(19) United States
(12) Patent Application Publication
(10) Pub. No.: US 2021/0023781 A1
(43) Pub. Date: Jan. 28, 2021

(54) Method for Resonant Ultrasonic Layer Consolidation in 3D Printing

(71) Applicant: Dwayne Allan Drake, Mechanicsville, MD (US)

(72) Inventor: Dwayne Allan Drake, Mechanicsville, MD (US)

(73) Assignee: United States of America as represented by the Secretary of the Navy, Patuxent River, MD (US)

(21) Appl. No.: 16/934,391

(22) Filed: Jul. 21, 2020

Related U.S. Application Data
(60) Provisional application No. 62/877,451, filed on Jul. 23, 2019.

(51) Int. Cl. B29C 64/188; B29C 64/118

(52) U.S. Cl. CPC B29C 64/188; B33Y 10/00; B29C 64/118

(57) ABSTRACT

This patent describes an improvement to 3D printing which includes applying ultrasound waves on the print bead such that ultrasonic resonance occurs and fills unwanted voids and improves final print robustness.

### STATEMENT OF GOVERNMENT INTEREST

The invention described herein may be manufactured and used by or for the Government of the United States of America for governmental purposes without payment of any royalties thereon or therefor.

### BACKGROUND

Three-Dimensional (3D) printing is a manufacturing method that uses a raw material (media) to build up a part from its constituent material. Conventional historical manufacturing has used injection molding, stamping, casting, or machining to remove material or manipulate bulk liquid material to build a part all at once. 3D printing has the advantage that parts can be made with physical structures not makeable in any other way, such as a solid body with several internal voids disposed within the structure. Fused Deposition Modeling (FDM) is an additive process whereby media (typically lengths or polymer filament such as PLA) is fused together by depositing a semi-liquid stream, or bead, of plastic, layer by layer in a specified pattern to create a 3D object. During the printing process, the bead resembles toothpaste being expelled from a toothpaste tube.

Unfortunately, FDM 3D printed parts typically suffer from a marked reduction in part strength in the “print direction.” The print direction is be defined as the direction perpendicular from the base on which the part is being made, also known as the build plate.

Another unfavorable property of FDM 3D printed parts is the tendency for the printing process to leave unintended voids in the part as it is being printed, with parallel rows of deposited media, or beads, having diamond shaped or triangular shaped voids between adjacent layers and print beads where less media is deposited. This reduces both the strength of the final part, as well as its stiffness. The reduction in strength in the direction of the print direction is caused by less than perfect adhesion between media as it is deposited in a liquid or semi-solid state in the already deposited media. This occurs both in the print direction and between adjacent beads of media, but it is more pronounced in the print direction as planes of low-adhesion are created as each successive plane is deposited during the build.

### SUMMARY

The present invention is directed to a method for resonant ultrasonic layer consolidation in 3D printing with the needs enumerated above and below.

The present invention is directed to a method of 3D printing which includes applying ultrasound waves at a location where a print bead is being deposited. The effect is to agitate the inter-bead interface, much in the same way as a workman depositing drywall mud on a seam will work the fluid mud back and forth, pressing it into the seam, causing it to adhere to the wallboard.

It is a feature of the present invention to provide a method of 3D printing wherein there are little to no unwanted voids in the part printed. The high-frequency ultrasound also causes the media to tend to flow more readily, tending to reduce the voids which result from the deposit of media during a print.

It is a feature of the present invention to reduce the amount of interlaminar voids in the final printed part.

It is a feature of the present invention to improve the quality of 3D FDM printed parts by improving the adhesion between media as it is being deposited, and media already deposited, both inter-layer and intra-layer. This is accomplished by agitating material being ejected from the print head using ultrasonic energy, ideally inducing resonance in the print bead. The closer the agitation ultrasonic signal is to resonance, the less ultrasonic power required in the ultrasonic transducer. Resonance between the signal and print bead is desired but not critical. The key feature is the agitation of the print bead by ultrasonic energy, improving the adhesion between the media being deposited and the already deposited media.

### DESCRIPTION

The preferred embodiments of the present invention are illustrated by way of example below. The method of 3D printing includes applying ultrasound waves on the print bead such that ultrasonic resonance occurs on the print bead and fills any unwanted voids. This technique uses waveguides that guide and direct ultrasonic energy toward the print nozzle, from where the print bead from the 3D machine is being deposited. Resonance in the print bead causes it to move slightly as it is being deposited, both improving the adherence to existing already-printed material and reducing voids and improve surface adhesion.

In the description of the present invention, the invention will be discussed in a military environment; however, this invention can be utilized for any type of application that requires use of 3D printing.

This invention is primarily for the process of using high power and resonant ultrasound to consolidate layers in 3D FDM prints though the agitation of the print bead as it is being deposited, much in the same way a person finishing drywall will press drywall compound or “mud” against a seam and work it back and forth to ensure a superior bond between the drywall compound and the wallboard. A prototype testbed was used to determine if the process is viable, and is not intended to be the specific design for use in all cases. This is intended to be a process or feature added to existing designs of 3D FDM printers, intending to improve and enhance the quality of prints, which those existing printers can attain.

One way of using this process is to attach an ultrasonic transducer to the print nozzle using a waveguide. Ultrasound energy is then delivered to the print nozzle through the waveguide, agitating the fresh bead as it is being deposited onto an existing printed part. The bead media is moved a fraction of the bead diameter many times as it is being laid down improving its adhesion to the existing beads. The local agitation of the bead will close voids and improve surface adhesion through direct motion of the bead as well as improved flow of the media.

The invention can be seen as a modification to a 3D printer to include a driver for a high-power ultrasonic transducer such that the transducer creates an ultrasonic resonance in the print bead and voids are all closed as a result of the resonance. Testing has shown that there was a significant increase in the stiffness of the ultrasonically tested specimens, as measured by reduced test extension at ultimate load.

This invention uses the application of ultrasound to induce resonance in the print bead of a 3D printer. The resonance is intended to agitate the “print bead” in such a way as to cause the liquid printing media to fill hitherto unfilled voids and to cause a blending at the interface to existing printed media or substrate. The significance of the resonance is that it preferentially causes motion only at the print bead where it is the softest.

Lower power ultrasound may be used if the driving transducer is tunable to a range of frequencies over a relatively broad band. The natural frequency of the bead will vary with the size of the bead, its temperature, and configuration during printing with respect to existing (already printed) material.

Linear eigenvalue analysis shows the approximate resonant frequency of the print bead as a first approximation to be 100 Khz for stiff print media and a 1.0 mm nozzle. Many ultrasonic transducers are designed to drive a small frequency band around a center frequency with considerable power drop-off away from the center band, and so a high-power transducer can be used to allow energy available at frequencies away from the center lobe to have enough power to energize the bead, resonantly activating a wider range of nozzle diameters used on a printer. The higher available ultrasound energy also improves the media flow characteristics, improving bead entry into otherwise existing voids.

One embodiment of the invention uses the addition of a 200-watt ultrasonic transducer to an existing 3d FDM printer (a Lulzbot Mini 2) to agitate the FDM media as it is being deposited.

Samples were printed using this printer both with and without ultrasound driving in place. A one-way Analysis of Variance (ANOVA) was performed to determine whether data from groups of treated and untreated samples have a common mean. In this case, ANOVA was used to determine if the mean value of [Load/Extension] at fracture of untreated additive manufactured parts were significantly different between groups manufactured with ultrasonic resonance.

ANOVA is based on the assumption that all sample populations are normally distributed. This assumption was verified for the data in each group of this analysis using an Anderson-Darling test, which failed to reject the null hypothesis that data in each group is from a normal distribution at a 5% significance level, i.e. the data most likely come from populations with normal distributions. Furthermore, a normal probability plot of the data showed the tendency of the data to follow a straight line which represents a fitted normal distribution.

The ANOVA showed variability in the model by source, the F-statistic for testing the significance of this variability, and the p-value for deciding on the significance of this variability. With a p-value of 0.0273, the null hypothesis that the data group variance is not significantly different can be rejected at a significance at 0.01. The same cannot said to be true at a significance level of 0.05. Thus, the true means of the data from each group are not the same and there was a significant difference between parts printed with and without ultrasonic treatment with 95% confidence intervals on the mean. A significant improvement was demonstrated in the stiffness of 3D parts as printed using this method, as well as a significant reduction in the presence of voids in the parts. Moreover, utilizing the current invention, testing has shown there is an improvement in the quality of the specimens with respect to voids.

When introducing elements of the present invention or the preferred embodiment(s) thereof, the articles “a,” “an,” “the,” and “said” are intended to mean there are one or more of the elements. The terms “comprising,” “including,” and “having” are intended to be inclusive and mean that there may be additional elements other than the listed elements.

Although the present invention has been described in considerable detail with reference to certain preferred embodiments thereof, other embodiments are possible. Therefore, the spirit and scope of the appended claims should not be limited to the description of the preferred embodiment(s) contained herein.

What is claimed is:

1. A method of 3D printing comprising of:
Applying ultrasound waves at a location where a print bead is being deposited such that ultrasonic resonance occurs in the print bead improves the resulting robustness of the printed part.
